(19) United States
(12) Patent Application Publication
(10) Pub. No.: US 2004/0003160 A1
(43) Pub. Date: Jan. 1, 2004

(54) Method and apparatus for provision, access and control of an event log for a plurality of internal modules of a chipset

(76) Inventors: John P. Lee, Tempe, AZ (US); Atul Kwatra, Chandler, AZ (US); Aniruddha P. Joshi, Chandler, AZ (US)

Correspondence Address: KENYON & KENYON, 1500 K STREET, N.W., SUITE 700, WASHINGTON, DC, 20005, US

(21) Appl. No.: 10/183,640

(22) Filed: Jun. 28, 2002

(51) Int. Cl. G06F 13/14

(52) U.S. Cl. 710/305

(57) ABSTRACT

Embodiments of the present invention relate to providing system management and control of chipset modules using an external micro controller. In an embodiment of the present invention, a SMB buffer read command including a buffer address may be received from an external micro-controller. Internal bus access may be requested from a bus arbiter. If bus access is granted, the SMB buffer read command may be sent to a module identified by the buffer address. The module is at least one of a plurality of modules having an associated data buffer to log data related to the operation of the module. The contents of the data buffer associated with the module may be received and forwarded to the external micro-controller.

### TECHNICAL FIELD

The present invention relates to computer chipsets. In particular, the present invention relates to providing system management and control of internal modules of a chipset using an external micro controller.

### BACKGROUND OF THE INVENTION

A typical computer system consists of several basic components, including a central processor, volatile and non-volatile memory, and various peripheral devices, including graphics controller(s), mass storage devices, and input/output devices. A chipset connects these computer system components together, and manages the flow of information between them. Several different communications protocols may be used by the computer system, including, for example, Peripheral Component Interconnect (PCI), Small Computer System Interface (SCSI-2, ANSI, etc.), Universal Serial Bus (USB), system management interface, etc.

Historically, computer system chipsets use a Northbridge/Southbridge architecture, in which the functionality of the chipset is apportioned between two basic chips, or components, a Northbridge chip and a Southbridge chip, connected via a hublink bus. The Northbridge chip connects the central processor to main/secondary memory, graphics controller(s), and the hublink bus, while the Southbridge chip connects all the other Input/Output (I/O) devices to the hublink bus. The I/O devices are indirectly connected to the central processor via various external busses and the hublink on the Northbridge chip.

A chipset, developed by the Intel Corporation of Santa Clara, Calif., uses an accelerated hub architecture. In this chipset, the functionality of the traditional Northbridge and Southbridge chips is divided among three basic components, the Memory Controller Hub (MCH), the I/O Controller Hub (ICH), and the Firmware Hub (FWH). These hubs are connected using a high-speed, proprietary data bus, (hub bus), rather than the PCI bus. As the name suggests, the ICH provides I/O functionality similar to that residing in the Southbridge chip, and may include modular components connected internally using a variety of internal buses. The ICH may also include various external bus interfaces, such as, for example, a PCI bus interface, or a system management bus (SMBus) interface.

In the current chipset configuration (e.g., ICHx type chipset), there appears to be no mechanism to permit an external micro-controller access to an event history log associated with the various chipset components.

### BRIEF DESCRIPTION OF THE DRAWINGS

FIG. 1 is a block diagram of a partial computer network in accordance with an embodiment of the present invention.

FIG. 2 is a diagrammatic representation of a data buffer in accordance with an embodiment of the present invention.

FIG. 3 is a flowchart illustrating a method in accordance with embodiments of the present invention.

### DETAILED DESCRIPTION

Embodiments of the present invention provide a data buffer coupled to each internal module or device located on a chipset. The data buffer may store an event log containing information related to commands received by the internal module. The chipset configuration, in accordance with embodiments of the present invention, may enable an external micro-controller to access each event log contained in the data buffer associated with each module. The information included in the event log may be used to help detect, diagnose and/or repair possible faults in the module, system and/or network architecture.

In embodiments of the present invention, the external micro-controller may access the event log stored in the buffer with or without the presence of an operating system (OS) running on the computer system. In embodiments of the present invention, the external micro-controller may operate on a secondary operating system (OS) independent from the higher level OS running on the computer system. The secondary OS may operate in the background, with or without the presence of a higher level OS running. The external micro-controller may access the stored buffer data in the background independent of the central processing unit and/or the higher level OS running.

A data path may be provided from the external micro-controller to the data buffers corresponding to each module. Access to the data buffers may be permitted by an external micro-controller using a system management bus interface via a system management bus controller. Advantageously, the chipset architecture of the present invention offers system management capabilities while maximizing system availability.

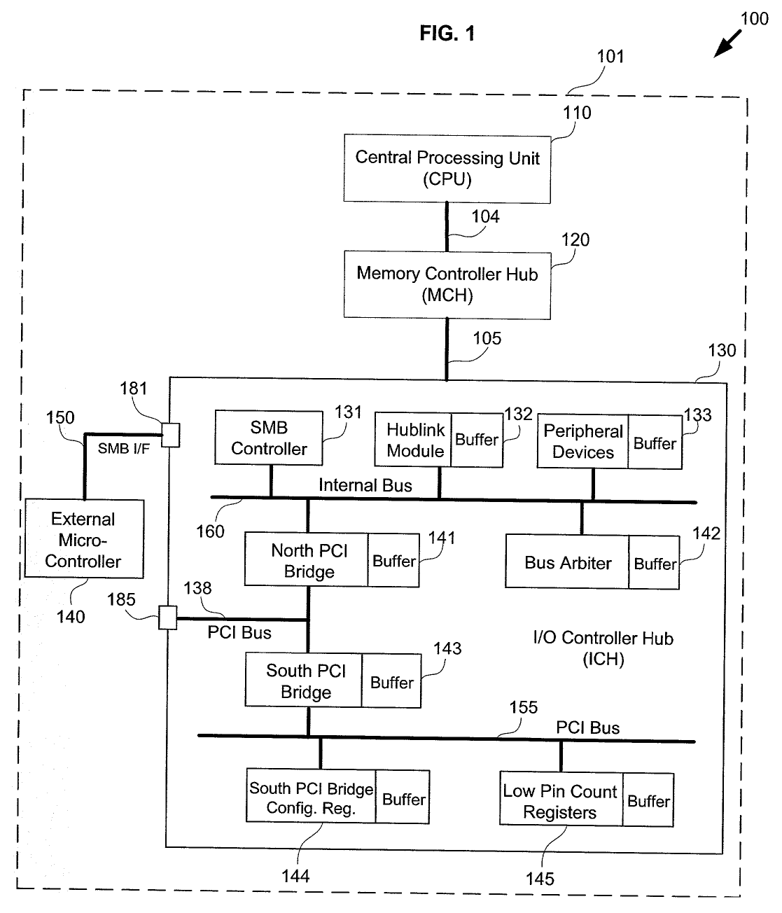

FIG. 1 is a partial block diagram of a system 100 in which the embodiments of the present invention find application.

In embodiments of the present invention, system 100 may include additional computers, modules and/or devices that are not shown for convenience. The network 100 may be a local-area network (LAN), a wide-area network (WAN), a campus-area network (CAN), a metropolitan-area network (MAN), a home-area network, an Intranet, Internet and/or any other type of computer network. It is recognized that embodiments of the present invention can be applicable to two computers that are coupled together in, for example, a client-server relationship or any other type of architecture such as peer-to-peer network architecture. The network 100 may be configured in any known topology such as a bus, star, ring, etc. It is further recognized that network 100 may use any known protocol such as Ethernet, fast Ethernet, etc. for communications.

As shown in FIG. 1, the system 100 is a partial representation of client computer 101 that is coupled to an external micro-controller 140 via a communication path, for example, a system management bus interface (e.g., SMBUS I/F) 181 using an external system management bus (SMBus) 150.

In accordance with embodiments of the present invention, additional clients 101 may be included in the network 100 coupled to a management console or computer (not shown). In this case, logged buffer data gathered by the micro-controller 140 for each client 101 may be shared with the management console via the network connection. This information may be centrally stored in the management console and may be used for management and/or maintenance purposes.

Additionally, it is recognized that the devices such as external micro-controller 140 and/or client 101 may be coupled to each other using a wireless interface and/or a wireless communications protocol. Embodiments of the present invention may find application in a personal digital assistant (PDA), a laptop, a cell phone, and/or any other handheld and/or desktop device.

In embodiments of the present invention, client computer 101 may include a CPU 110 connected to a chipset 130 via a memory controller hub (MCH) 120. The CPU 110 may be coupled to the MCH 120 using, for example, a host bus 104 and the MCH 120 may be coupled to the chipset 130 using bus 105. In embodiments of the present invention, bus 105 may be a PCI bus, a high-speed proprietary data bus (e.g., a hub bus) and/or any other proprietary bus.

As indicated above, the micro-controller 140 may be coupled to the chipset 130 via the interface 181 using an external SMBus 150 and/or other external interface/bus combination.

The chipset 130 of computer system 101 may include, for example, a system management bus (SMB) controller 131, hublink module 132, peripheral devices 133, north PCI bridge 141, bus arbiter 142, south PCI bridge 143, south PCI bridge configuration registers (PCI registers) 144 and low pin count registers (LPC) 145. The system management bus (SMB) controller 131, hub-link module 132, peripheral devices 133, north PCI bridge 141 and bus arbiter 142 may all be connected to internal bus 160 that may be a silicon bus. The internal bus 160 may be, for example, an ISA bus, a SMBus, a PCI bus and/or any other type of bus. The PCI registers 144 and LPC 145 may be coupled to the south PCI bridge 143 that is coupled to the north PCI bridge 141 via PCI bus 138. PCI Bus 138 couples south the PCI bridge 143, PCI registers 144 and LPC 145 to internal bus 160. The PCI bus 138 may also provide an external connection via an external PCI interface 185.

Typically, the north PCI bridge 141 connects to main/secondary memory, graphics controller(s), and the peripheral component interconnect bus (PCI bus). The south PCI bridge 143 may connect all the other I/O devices to the PCI bus 105. The plurality of I/O devices may be indirectly connected to the CPU 110 via the PCI bus 105 and the Host-PCI bus 104 via the MCH 120. MCH 120 may interface with chipset 130 via the hub-link module 132.

In embodiments of the present invention, system 100 includes a plurality of internal and/or external communication buses that connect the various components internal to and/or external to the client 101. These busses may include, for example, host bus 104, PCI or proprietary bus 105, internal bus 160, SMBus 150, PCI bus 138, PCI bus 155 and/or other PCI buses (not shown).

In embodiments of the present invention, as shown in FIG. 1, each module, for example, the north PCI bridge 141, bus arbiter 142, south PCI bridge 143, PCI registers 144, LPC 145, hublink module 132, peripheral devices 133 may include an associated data buffer. In accordance with embodiments of the present invention, each data buffer may be a data buffer of predetermined depth that may be added to each internal module on the chipset 130. It is recognized that the size of the data buffer for each module may be the same or may vary for different modules. It is recognized that additional modules and/or components of the computer system 101 and/or system 100 may include a corresponding data buffer in accordance with embodiments of the present invention.

In embodiments of the present invention, the data buffer associated with a module may be an N-word deep data buffer, where N is an integer. For example, an N-word deep buffer may store a log of, for example, N commands, addresses and/or time stamps. Each entry may be one word (i.e., 2 bytes) in length. It is recognized that size of each data buffer may be, for example, one byte, one or more words, etc. It is recognized that each entry could be one word, two words, or three words or more in size.

In embodiments of the present invention, each data buffer may, for example, include a data log with one or more commands, addresses, and/or time stamps that may be received by the corresponding module. In embodiments of the present invention, the commands in the log may be sent from another module or device and addressed to the receiving module for processing. As will be discussed below in more detail, the data log can provide information that may be used to help detect, diagnose and/or repair possible faults in the module, system and/or network.

In embodiments of the present invention, the external micro-controller 140 may be, for example, an 8, 16 or 32 bit microprocessor. The micro-controller 140 may be located internal or external to the motherboard, and may operate using a secondary OS independent of the higher level OS running on the computer system. Accordingly, the micro-controller 140 may operate in the background of the higher level OS. In accordance with embodiments of the present invention, the micro-controller 140 may still be operational even if the higher level OS of computer system 101 in not in operation and/or is in a fault condition. Advantageously, micro-controller 140 may access the log contained the various data buffers even when the computer system 101 is locked up or in a fault state. For example, if a device failure causes the higher level operating system to freeze, the micro-controller 140 may be used to determine which of the modules 132-133 or 141-144 caused the failure. If one of the modules is identified, the identified module and/or device may be reset to free the higher level operating system. In this case, re-booting the entire computer system may be avoided.

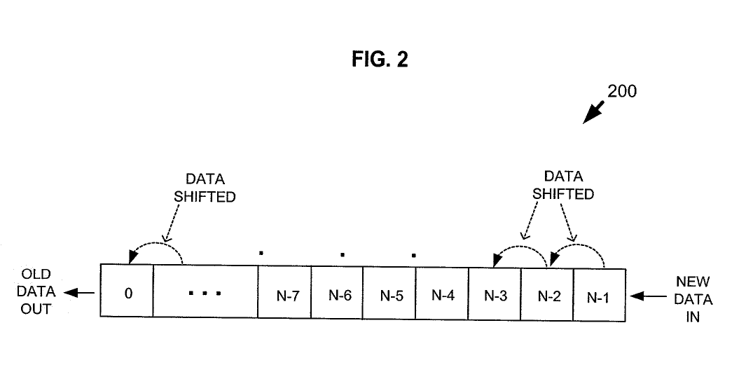

FIG. 2 is a diagrammatic representation of a data buffer 200 in accordance with embodiments of the present invention. In embodiments of the present invention, data buffer 200 may be coupled to each of the modules of chipset 130, as shown in FIG. 1. In embodiments of the present invention, the data buffer 200 may store, for example, a new command, address, time stamp, or other information related to an event and/or fault on and/or involving the corresponding module. The data buffer may be embodied in a random access memory (RAM) or another type of memory for storing information related to the corresponding module.

In embodiments of the present invention, data buffer 200 may employ a first-in-last-out (FILO) type of shift algorithm. It is recognized that another type of algorithm may be employed in alternative embodiments of the invention. As shown in FIG. 2, when new data is received, the data may be shifted into the newest data location at address N−1. The current data in address N−1 may get shifted into data location N−2. Likewise, the current data in N−2 may get shifted in data location N−3, etc. The oldest data in address 0 may be discarded.

In accordance with embodiments of the present invention, each module (e.g., modules 132-133 and 141-145) having a corresponding buffer 200 can store a history of the last N commands, addresses, time stamps, etc. received by the corresponding module. The command may be a read, write or other type of command that is received at one of the modules 132-133 and 141-145. Typically, the command may include the address of the module that received the command. The time stamp may represent the time when the command was received at the module. This command, address and/or time stamp data may be stored in the data buffer 200 corresponding to one of the modules 141-145. In embodiments of the present invention, this data may be accessed by the external micro-controller 140. As will described below in more detail, the external micro-controller 140 may retrieve and examine the history of received commands for system management, diagnosis and/or repair purposes.

In embodiments of the invention, external micro-controller 140 may access the data buffer 200 using the SMB controller 131 via external system management bus 150. During normal operation, the external micro-controller 140 can periodically access the data buffer 200 by sending a SMB buffer read command to the SMB controller 131. The SMB buffer read command including the address identifying the buffer and/or associated module for which the stored information is desired. The SMB controller 131 may request access to the data buffers 200 associated with each module 132-133 and 141-145 from bus arbiter using internal bus 160. In embodiments of the present invention, the bus arbiter 142 contains logic to the arbitrate between traffic or requests from, for example, the CPU 110, the external micro-controller 140 and other devices and or modules in system 100. By providing an external connection to the internal bus 160, micro-controller 140 can access the plurality of data buffers 200 for each of the modules 132-133 and 141-145.

It is recognized that the SMB buffer read commands may be issued and/or processed using normal SMB protocol and may use an SMB based signal. Although SMB buffer read commands are used herein, it is recognize that these commands may be read commands, write commands and/or other type of commands.

In embodiments of the present invention, the SMB controller 131 may request bus arbiter 142 for access to the internal bus 160. As indicated above, the bus arbiter 142 controls access to internal bus 160. If the internal bus 160 is being accessed by another device such as CPU 110, the bus arbiter 142 may not grant access to the SMB controller 131. When the internal bus 160 is available, management controller 131 is granted access to the bus 160. The SMB controller 131 places the SMB buffer read command including the address of the module and/or buffer to be read on internal bus 160. The SMB buffer read command is forwarded to the appropriate module 141-145 identified by the included address. In embodiments of the present invention, the SMB buffer read command may identify only a portion of the buffer to be read. Alternatively, the SMB buffer read command may request contents of the entire data buffer.

In embodiments of the present invention, the module identified by the buffer address may receive the buffer read command and processes the read request. The module gathers the requested buffer data as identified in the SMB buffer read command.

In embodiments of the invention, the module having the buffer address identified by the SMB buffer read command retrieves the requested buffer data from the corresponding buffer. The module may request the bus arbiter 142 for access to the internal bus 160. When the internal bus 160 access is granted, the module may post the requested buffer data on internal bus 160. The posted buffer data may be retrieved from the internal bus by the SMB controller 131. The SMB controller 131 may forward the buffer data (e.g., the contents of the data buffer identified in the SMB buffer read command) to the external micro-controller 140 via the SMB I/F 181 and external SMBus 150.

In embodiments of the present invention, the contents of the data buffer may be used by the micro-controller 140 for system management purposes. For example, the micro-controller 140 may use the contents of the buffer coupled to the PCI registers 144 to monitor and/or detect faults on peripheral cards and/or devices that are connected to the chipset, perform diagnostics on a failing device, isolate the failing device from the system and possibly recover and/or repair the device an/or system. PCI cards may include, for example, PCI LAN cards, PCI audio cards, PCI video cards, PCI SCSI cards, etc.

As indicated above, embodiments of the present invention may permit an external micro-controller 140 to access to the contents of the data buffers coupled to the various modules 132-133 and 141-145 even during system lockup and/or the absence of an operating system. Accordingly, even during system lockup sufficient information may be accessible to diagnose, isolate and/or repair the problem.

In an embodiment of the present invention, the micro-controller 140 may request the contents of associated data buffers on a periodic basis from modules 132-133 and 141-145. The micro-controller 140 may examine the contents of the data buffer to examine the history of the commands, address and time stamps received at each module. If the system 101 is operating normally, no further action may be required by micro-controller 140.

In embodiments of the present invention, if there is a fault on the system 101 such as system lock up or a module that is not responding to request by another device such as the CPU 110, the external micro-controller may attempt to identify the fault by examining the contents of one or more data buffers associated with modules 132-133 and 141-145. For example, if a plurality of commands in stored in the buffer of one of the modules 141-145 are the same command to the same address, this may indicate that the targeted device is not responding. This may indicate that the targeted device is malfunctioning. In this case, the external micro-controller 140 may send a read command to the targeted device to diagnose the possible problem. For example, the external micro-controller 140 may send the read command to the targeted device to access, for example, device command, device status, error status information, etc. This information may be used to diagnose the problem and, if needed, to inform the system console or server of the malfunction so that appropriate action may be taken to help maximize system availability.

In embodiments of the present invention, the values of one or buffers associated with modules 132-133 and 141-145 may be used to determine, for example, the total amount of time each module is in operation and/or when was the last time the module has been accessed. In one example, the total time of the operation time may be compared with the mean or average time before failure for the particular module and used to maintain or replace the module before actual failure of the device. For example, the time stamps stored in the data logs may be examined to determine the frequency with which a particular module is accessed. This may help to determine whether the module or device is being over used or under used. Such information may be used to replace and/or maintain the module, card and/or device to avoid a possible failure.

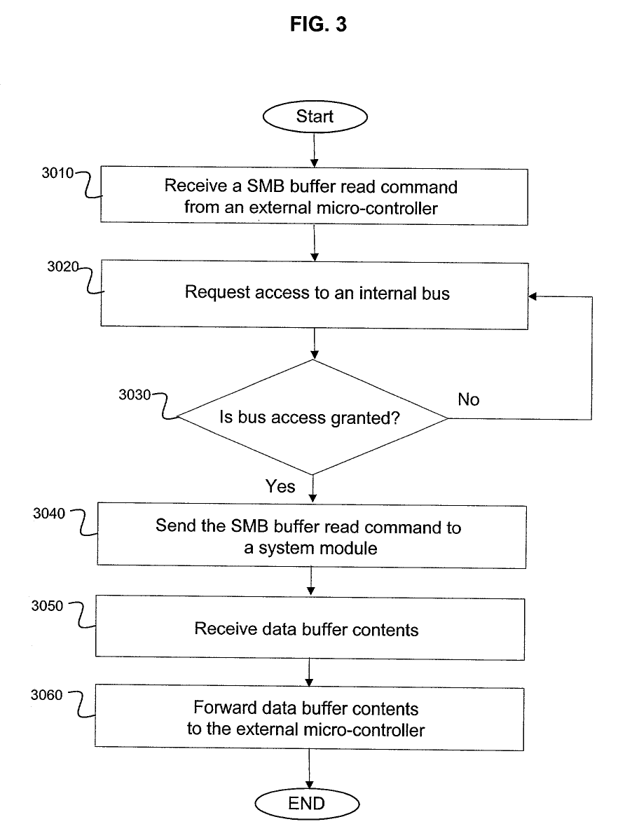

FIG. 3 is a flowchart illustrating an method in accordance with an embodiment of the present invention. In one embodiment of the present invention, a SMB buffer read command including a buffer address is received from the external micro-controller 140, as shown in 3010. As indicted above, the micro-controller may send the SMB buffer read command based on a periodic interval and/or during a known faulty condition. The SMB controller 131 or another device may receive the SMB buffer read command from the external micro-controller 140. As shown in 3020, access to the internal bus 160 is requested from the bus arbiter 142. Once bus access is granted, the SMB buffer read command may be sent to a module on the chipset 130 identified by an address included in the SMB buffer read command on the chipset 130, as shown in 3030-3040. The module may be any of the modules, for example, modules 141-145 having corresponding buffers. The address included in the SMB buffer read command may identify the buffer and/or may identify the module associated with the buffer.

If, on the other hand, bus access is not granted, the SMB controller 131 may continue to request bus access until granted, as shown in 3030 and 3020.

After the module identified by the address receives the SMB buffer read command, the module may retrieve contents of its associated data buffer. The module may send the retrieved contents of the data buffer to the SMB controller 131 once access to the internal bus 160 is granted from arbiter 142. As shown in 3050, the requested data buffer contents may be received by the SMB controller 131. As shown in 3060, the data buffer contents are forwarded to the external micro-controller 140.

In embodiments of the present invention, the external micro-controller 140 examines the contents of the data buffer from one or more of the associated modules 141-145 to determine if there is a fault on the system 101. As indicated above, the external micro-controller may examine and log this information. The external micro-controller may use the contents of the data buffers to identify, diagnose and/or debug a fault on the computer system 101. The external micro-controller 140 may use the history of the information logged in its memory to predict when a module and/or device may fail based on time of operation. In this manner, action may be taken by an operator before the module and/or device fails.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A chipset comprising:
an internal bus;
a plurality of modules coupled to the internal bus;
a memory coupled to each of the plurality of modules to store a history log; and
a system management controller coupled to the internal bus, wherein the system management controller to send a read command including an address to the module identified by the address via the internal bus and responsive to the read request, the module identified by the address returns data contained in the history log to the system management controller.

2. The chipset of claim 1, wherein the internal bus is a silicon bus.

3. The chipset of claim 1, further comprising:
a bus arbiter coupled to the internal bus, wherein the bus arbiter to grant access to the internal bus when the internal bus is available.

4. The chipset of claim 1, wherein the history log contains one or more commands received by the corresponding module.

5. The chipset of claim 1, wherein the history log contains one or more addresses received by the corresponding module.

6. The chipset of claim 1, wherein the wherein the history log contains one or more time-stamps related to the commands received by the corresponding module.

7. The chipset of claim 1, wherein the system management controller is coupled to an external micro-controller, wherein the external micro-controller generates the read command and forwards the read command to the system management controller.

8. The chipset of claim 1, wherein one of the plurality of modules coupled to the internal bus is at least one of a north peripheral component interconnect bridge, south peripheral component interconnect bridge, a peripheral device module, a bus arbiter, a hub-link module, south peripheral component interconnect configuration register and a low pin count register.

9. A method comprising:
receiving a SMB buffer read command including a buffer address from an external micro-controller;
requesting internal bus access from a bus arbiter;
if bus access is granted, sending the SMB buffer read command to a module identified by the buffer address, wherein the module is at least one of a plurality of modules having an associated data buffer that logs data related to the operation of the module;
receiving contents of the data buffer associated with the module identified by the buffer address; and
forwarding the received contents of the data buffer to the external micro-controller.

10. The method of claim 9, further comprising:
receiving contents of the data buffer associated with the module identified by the buffer address at the micro-controller; and
analyzing the contents of the data buffer to determine whether a targeted device is malfunctioning.

11. The method of claim 10, further comprising:
sending a targeted read command to the targeted device to retrieve device command, device status or error status if the targeted device is determined to be malfunctioning.

12. The method of claim 9, wherein the contents of the data buffer associated with the identified module includes one or more commands, addresses and associated time stamps.

13. The method of claim 9, further comprising:
determining whether the one or more commands are same commands directed to same addresses.

14. The method of claim 9, wherein the contents of the data buffer associated with the identified module include a history of at least one of a command, address and an associated time stamp.

15. The method of claim 9, further comprising:
denying bus access if the internal bus is busy.

16. The method of claim 9, further comprising:
using a first-in-last out type of shift algorithm at each of the associated data buffer.

17. The method of claim 9 further comprising:
retrieving contents of the data buffer associated with the identified module;
requesting access to the internal bus; and
when bus access is granted, posting the contents of the data buffer on the bus.

18. The method of claim 17, further comprising:
receiving contents of the data buffer at the system management controller.

19. The method of claim 9, further comprising:
periodically sending the SMB buffer read command including the buffer address by the external micro-controller.

20. A system comprising:
a external communications bus;
an external micro-controller coupled to the external communications bus;
a system management bus controller coupled to the external communications bus and an internal communications bus;
a plurality of modules coupled to the internal bus, each module having an associated memory, wherein the external micro-controller to issue a read command to the system management bus controller via the external communications bus, the system management bus controller to receive the read command and to forward the read command to at least one module of the plurality of modules via the internal bus and wherein responsive to the SMB buffer read command, the at least one module to forward contents of the memory to the system management bus controller via the internal bus.

21. The system of claim 20, wherein the read command issued by the external-micro-controller includes an address identifying the at least one of the plurality of modules.

22. The system of claim 20, wherein each memory associated with the plurality of modules stores commands received by the associated module.

23. The system of claim 20, wherein each memory associated with the plurality of modules stores addresses received by the associated module.

24. The system of claim 20, wherein each memory associated with the plurality of modules stores time stamps identifying when a command was received by the associated module.

25. The system of claim 20, further comprising:
a bus arbiter coupled to the internal bus, the bus arbiter to receive a request for internal bus access from the system management bus controller and to grant access when access to the internal bus is available.
